(19) United States
(12) Patent Application Publication
(10) Pub. No.: US 2007/0201301 A1
(43) Pub. Date: Aug. 30, 2007

(54) BEVERAGE POURING SYSTEMS

(76) Inventor: Steve R. Klepinger, Sherwood, OR (US)

Correspondence Address: STONEMAN LAW OFFICES, LTD, 3113 NORTH 3RD STREET, PHOENIX, AZ, 85012, US

(21) Appl. No.: 11/677,969

(22) Filed: Feb. 22, 2007

Related U.S. Application Data
(60) Provisional application No. 60/776,840, filed on Feb. 24, 2006.

(51) Int. Cl. B01F 11/00; G01F 11/00

(52) U.S. Cl. 366/110; 366/216

(57) ABSTRACT

A system for improved dispensing of partially frozen beverages from a container. The system comprises a mechanical vibrator adapted to contact the outer wall of a container such as a blending pitcher. The interaction of the partially frozen beverage with the vibrating outer wall reduces the effective viscosity of the mixture as an aid to pouring.

### CROSS-REFERENCE TO RELATED APPLICATION

The present application is related to and claims priority from prior provisional application Ser. No. 60/776,840, filed Feb. 24, 2006, entitled “SLUSHY BEVERAGE POURING SYSTEMS”, the contents of which are incorporated herein by this reference and are not admitted to be prior art with respect to the present invention by the mention in this cross-reference section.

### BACKGROUND

This invention relates to providing a system for improved dispensing of partially frozen beverages from a container. More particularly this invention relates to providing a system for altering the flowability of a beverage during pouring of the beverage from a container such as a blending pitcher.

The wide availability of mechanically produced ice early in the 20^{th} century greatly expanded the use of ice in consumed beverages. Even today, the popularity of partially frozen beverages continues to increase worldwide. Many of these slushy products are manually prepared in small quantities utilizing a motorized blender. Typically, the preparation of beverages such as slushies, smoothies, milkshakes, frozen or iced coffee beverages, frozen alcoholic beverages, etc., entails the crushing of one or more frozen materials to produce a viscous mixture of liquids and frozen solids. Preparing and dispensing these partially frozen beverages has never been an easy task.

No system currently exists which provides ease in dispensing partially frozen beverages from the interior of a container. A system providing ease of dispensing would thus be beneficial.

### OBJECTS AND FEATURES OF THE INVENTION

A primary object and feature of the present invention is to overcome the above-described issues.

Another primary object and feature of the present invention is to provide a system for improved dispensing of partially frozen (slushy) beverages from a container, with essentially no wasted time during the procedure.

It is a further object and feature of the present invention to provide such a system adapted to utilize existing commercial drink preparation equipment.

It is a further object and feature of the present invention to provide such a system incorporated into proprietary commercial drink preparation equipment such as a blending pitcher.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a system relating to improving pourability of at least one slushy beverage held within at least one container, such at least one container comprising at least one containment boundary adapted to contain such at least one slushy beverage and at least one fluid discharge through which such at least one slushy beverage may discharge from the at least one containment boundary, such system comprising: vibrator means for generating at least one mechanical vibration force having at least one frequency of oscillation; trigger means for triggering the operation of such vibrator means; and vibration transmitter means for transmitting such at least one mechanical vibration force from such vibrator means to the at least one containment boundary; wherein such vibration transmitter means comprises surface abutter means for providing at least one vibratable surface abuttable with such at least one containment boundary; wherein such surface abutter means comprises positioner means for assisting in positioning such surface abutter means in at least one operable position of abutment with the at least one containment boundary during such fluid discharge of such at least one slushy beverage from within the at least one containment boundary; and whereby pourability of such at least one slushy beverage through the at least one fluid discharge is improved by vibratory interaction with the at least one containment boundary receiving from such vibration transmitter means such at least one mechanical vibration force generated by such vibrator means.

Moreover, it provides such a system further comprising assembly support means for supporting such vibrator means, such trigger means, and such vibration transmitter means. Additionally, it provides such a system wherein such trigger means triggers the operation of such vibrator means by at least one pressure contact between the at least one containment boundary and such surface abutter means. Also, it provides such a system wherein such trigger means comprises frequency adjuster means for adjusting such at least one frequency of oscillation. In addition, it provides such a system wherein such frequency adjuster means comprises variable pressure adjuster means for adjusting such at least one frequency of oscillation in substantial correspondence to varying levels of pressure contact between the at least one containment boundary and such surface abutter means. And, it provides such a system wherein such assembly support means comprises surface support means for assisting in the stable support of such assembly support means on at least one substantially horizontal support surface.

Further, it provides such a system wherein: such assembly support means comprises pivot guide means for pivotally guiding such surface abutter means along at least one arc; wherein the at least one containment boundary is guidable along such at least one arc by such abutment with such surface abutter means; and wherein, while guided along such at least one arc, the at least one containment boundary receives such at least one mechanical vibration force by such abutment with such surface abutter means. Even further, it provides such a system wherein such assembly support means comprises removable attacher means for removably attaching such assembly support means to the at least one container.

In accordance with another preferred embodiment hereof, this invention provides a system relating to improving pourability of at least one slushy beverage held within at least one container, such at least one container comprising at least one containment boundary adapted to contain such at least one slushy beverage and at least one fluid discharge through which such at least one slushy beverage may discharge from the at least one containment boundary, such system comprising: at least one vibrator adapted to generate at least one mechanical vibration force having at least one frequency of oscillation; at least one trigger adapted to trigger the operation of such at least one vibrator; and at least one vibration transmitter adapted to transmit such at least one mechanical vibration force from such at least one vibrator to the at least one containment boundary; wherein such at least one vibration transmitter comprises at least one surface abutter adapted to provide at least one vibratable surface abuttable with such at least one containment boundary; and wherein such at least one surface comprises at least one positioner structured and arranged to assist in positioning such at least one surface abutter in at least one operable position of abutment with the at least one containment boundary during such fluid discharge of such at least one slushy beverage from within the at least one containment boundary; whereby pourability of such at least one slushy beverage through the at least one fluid discharge is improved by vibratory interaction with the at least one containment boundary receiving from such at least one vibration transmitter such at least one mechanical vibration force generated by such at least one vibrator.

Moreover, it provides such a system further comprising at least one assembly support adapted to support such at least one vibrator, such at least one trigger, and such at least one vibration transmitter. Additionally, it provides such a system wherein such at least one trigger triggers the operation of such at least one vibrator by at least one pressure contact between the at least one containment boundary and such at least one surface abutter. Also, it provides such a system wherein: such at least one trigger comprises at least one frequency adjuster adapted to adjust of such at least one frequency of oscillation; and such at least one frequency adjuster is user controllable. In addition, it provides such a system wherein such at least one frequency adjuster comprises at least one variable pressure adjuster adapted to adjust such at least one frequency of oscillation in substantial correspondence to varying levels of pressure contact between the at least one containment boundary and such at least one surface abutter.

And, it provides such a system wherein such at least one assembly support comprises at least one surface support structured and arranged to assist in the stable support of such at least one assembly support on at least one substantially horizontal support surface. Further, it provides such a system wherein: such at least one assembly support comprises at least one pivot guide to pivotally guide such at least one surface abutter along at least one first arc, and at least one swivel adapted to guide such at least one surface abutter along at least one second arc; wherein the at least one containment boundary is guidable along such at least one first arc and such at least one second arc by such abutment with such at least one surface abutter; and wherein, while guided along such at least one first arc and such at least one second arc, the at least one containment boundary receives such at least one mechanical vibration force by such abutment with such at least one surface abutter.

Even further, it provides such a system wherein such at least one assembly support comprises at least one removable attacher adapted to removably attach such at least one assembly support to the at least one container. Moreover, it provides such a system wherein such at least one attacher comprises at least one spring clip. Additionally, it provides such a system further comprising the at least one container; wherein such at least one container comprises at least one containment boundary adapted to contain such at least one slushy beverage, and at least one fluid discharge through which such at least one slushy beverage may discharge from the at least one containment boundary. Also, it provides such a system wherein: such at least one container comprises at least one blending pitcher adapted to assist in the preparation of such at least one slushy beverage; such at least one containment boundary of such at least one blending pitcher comprises at least one peripheral side wall having at least one bottom wall portion; such at least one peripheral side wall and such at least one bottom wall together comprise at least one interior portion; such at least one interior portion comprises at least one substantially open top portion defining such at least one fluid discharge, and at least one cutter blade adapted to assist in the preparation of such at least one slushy beverage; such at least one peripheral side wall comprises at least one grip adapted to assist manual gripping of such at least one blending pitcher; such at least one bottom wall comprises at least one adapter seat seatable on at least one blender seat of at least one motor base; and such at least one cutter blade comprises at least one rotational coupler to rotationally couple such at least one cutter blade with the at least one motor base.

In addition, it provides such a system wherein such at least one container comprises at least one coupler adapted to removably couple such at least one removable attacher to such at least one containment boundary. And, it provides such a system wherein: at least one of such at least one coupler and such at least one removable attacher comprises at least one post adapted to removably engage at least one socket; at least one of such at least one coupler and such at least one removable attacher comprises such at least one socket adapted to removably engage such at least one post; and such at least one coupler is removably coupled to such at least one removable attacher using such at least one post removably engaged within such at least one socket.

In accordance with another preferred embodiment hereof, this invention provides a beverage handling system relating to improving the pourability of at least one slushy beverage held within at least one pitcher by reducing the effective viscosity of such at least one slushy beverage during the arc of a pour, such system comprising: at least one pitcher support adapted to support the at least one pitcher during the arc of a pour; at least one support vibrator adapted to generate at least one vibration force to vibrate such at least one pitcher support; and at least one vibration transmitter adapted to transmit such at least one vibration force of such at least one pitcher support to such at least one pitcher.

In accordance with another preferred embodiment hereof, this invention provides a beverage handling system relating to improving the pourability of at least one slushy beverage comprising: at least one container adapted to contain such at least one slushy beverage; and at least one vibrator adapted to vibrate such at least one container; wherein such at least one container comprises such at least one vibrator. And it provides each and every novel feature, element, combination, step and/or method disclosed or suggested by this patent application.

### BRIEF DESCRIPTION OF THE DRAWINGS

FIG. 1 shows a perspective view illustrating a surface supported beverage-pouring unit of a beverage-pouring system according to a preferred embodiment of the present invention.

FIG. 2 shows a side view of the beverage-pouring unit of FIG. 1 operationally engaged with a blending pitcher during the dispensing of a slushy beverage into a serving container.

FIG. 3 shows another side view of the beverage-pouring unit of FIG. 2 illustrating a progressive dispensing of the slushy beverage into the serving container.

FIG. 4 shows a side elevational view illustrating the articulated motion of the beverage-pouring unit according to the preferred embodiment of FIG. 1.

FIG. 5 shows a side view, in partial section, illustrating the internal assembly arrangements of beverage-pouring unit of FIG. 1.

FIG. 6 shows an exploded view of the beverage-pouring unit of FIG. 1.

FIG. 7 shows a perspective view illustrating an alternate beverage-pouring unit of the beverage-pouring system comprising a spring-loaded mount adapted to mount the alternate beverage-pouring unit to a peripheral wall of a mixing pitcher according to another preferred embodiment of the present invention.

FIG. 8 shows a perspective view illustrating the alternate beverage-pouring unit mounted to the peripheral wall of the mixing pitcher of FIG. 7.

FIG. 9 shows a detailed perspective view of the alternate beverage-pouring unit of FIG. 7.

FIG. 10 shows a side view of the alternate beverage-pouring unit of FIG. 7.

FIG. 11 shows a side view illustrating an alternate beverage-pouring unit of the beverage-pouring system comprising a pin-mount adapted to mount the alternate beverage-pouring unit to a peripheral wall of a mixing pitcher according to another preferred embodiment of the present invention.

FIG. 12 shows a side view illustrating an alternate beverage-pouring unit of the beverage-pouring system mounted to a peripheral wall of a mixing pitcher according to another preferred embodiment of the present invention.

FIG. 13 shows the detail view 13-13 of FIG. 11 illustrating the mounting pin of the mixing pitcher according to another preferred embodiment of the present invention.

FIG. 14 shows a side view of the alternate beverage-pouring unit of FIG. 11.

FIG. 15 shows a rear view of the alternate beverage-pouring unit of FIG. 11 illustrating in greater detail the preferred mounting assembly.

### DETAILED DESCRIPTION OF THE BEST MODES AND PREFERRED EMBODIMENTS OF THE INVENTION

Beverage-pouring system 100 comprises a series of closely related embodiments adapted to fluidize a partially frozen beverage and/or improve pourability. Partially frozen beverages preferably comprise slushy beverages, preferably comprising a viscous suspension of frozen ice, similar to partly melted snow.

Beverage-pouring system 100 is adapted to improve the flow characteristics of the slushy beverage by agitating the mixture using a mechanical oscillator. While the specific mechanics governing the behavior of semi-frozen liquids is complex, and the underlying science is not fully understood, in general, applying a vibrational agitation to the complex physical structure of a slushy beverage results in a reduction in apparent viscosity within the mixture.

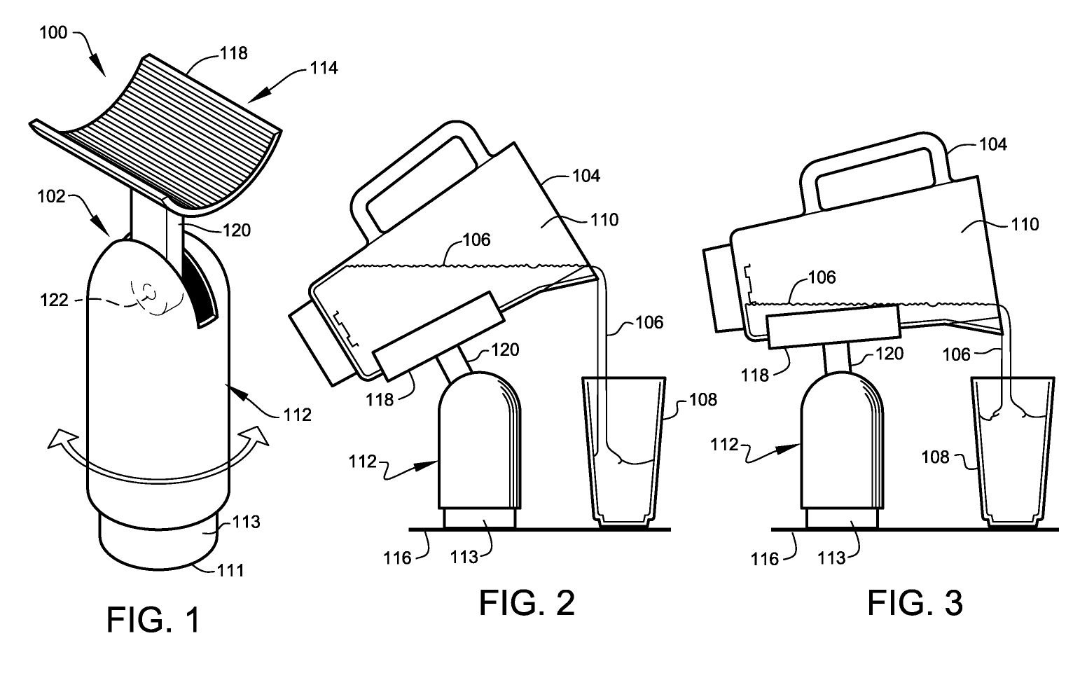

FIG. 1 shows a perspective view illustrating a surface supported beverage-pouring unit 102 of beverage-pouring system 100 according to a preferred embodiment of the present invention. FIG. 2 shows a side view of beverage-pouring unit 102 of FIG. 1 operationally engaged with blending pitcher 104 to assist in dispensing slushy beverage 106 into serving container 108. Referring now to both FIG. 1 and FIG. 2, preferably, beverage-pouring unit 102 is adapted to improve the pourability of slushy beverage 106 by supplying a vibrational force to containment wall 110 of blending pitcher 104 (at least embodying herein at least one containment boundary adapted to contain such at least one slushy beverage).

Preferably, beverage-pouring unit 102 comprises assembly-housing 112 (at least embodying herein assembly support means) adapted to house an external pivot cradle 114 and an internal vibration generator 113, as shown. Preferably, assembly-housing 112 is adapted to be supported on a substantially horizontal work surface 116, as shown. Preferably, the lower base portion 111 of beverage-pouring unit 102, most preferably the lower end of vibration generator 113, comprises a generally flat planar surface adapted to provide stable support over work surface 116, as shown (at least embodying herein surface support means for assisting in the stable support of such assembly support means on at least one substantially horizontal support surface). Preferably, lower base portion 111 comprises sufficient ballast weight to resist overturning during use. Upon reading the teachings of this specification, those of ordinary skill in the art will now understand that, under appropriate circumstances, considering such issues as intended use, size of unit, user preference, etc., other base arrangements, such as, for example, accommodations for bolted mounting to a support surface, clamping arrangements, projecting legs, enlarged base surfaces, etc., may suffice.

Preferably, upper pivot cradle 114 comprises shaped receiver 118 and pivot arm 120, as shown. Assembly-housing 112 is preferably adapted to provide to upper pivot cradle 114, multiple degrees of freedom, as shown. Preferably, pivot arm 120 is pivotally coupled to assembly-housing 112 at pivotal coupler 122, as shown. Preferably, pivot arm 120 is adapted to guide shaped receiver 118 along an arc-shape path about a central focus located at pivotal coupler 122, as shown (at least embodying herein pivot guide means for pivotally guiding such surface abutter means along at least one arc). In addition, assembly-housing 112 preferably provides an additional pivotal motion generally parallel to horizontal work surface 116, as indicated by the arrow depiction of FIG. 1. Preferably, this secondary degree of freedom allows shaped receiver 118 to rotate at least 180 degrees, most preferably 360 degrees about a rotational axis oriented approximately perpendicular to the planar surface of horizontal work surface 116, as shown. The above described multiple pivotal movements provides a highly flexible range of articulation allowing a user to freely adjust the position of blending pitcher 104 during a pour. Upon reading the teachings of this specification, those of ordinary skill in the art will now understand that, under appropriate circumstances, considering such issues as user preference, intended use, etc., other positioning features, such as bias springs to bias the pivot cradle to a specific resting position, clamps to assist in retaining the pitcher on the receiver, etc., may suffice.

Preferably, shaped receiver 118 is adapted to engage the outer peripheral surface of blending pitcher 104, as shown (at least embodying herein wherein such vibration transmitter means comprises surface abutter means for providing at least one vibratable surface abuttable with such at least one containment boundary). Blending pitcher 104 is generally representative of popular commercially available blending containers adapted for use with a motorized blender unit (not shown).

In the example embodiment of FIG. 1 and FIG. 2, the concave receiving surface of shaped receiver 118 is closely matched to the outer cylindrical shape of blending pitcher 104, as shown. This preferred shape correspondence assists in securely maintaining the position of blending pitcher 104 adjacent beverage-pouring unit 102 during pouring (at least embodying herein wherein such surface abutter means comprises positioner means for assisting in positioning such surface abutter means in at least one operable position of abutment with the at least one containment boundary during such fluid discharge of such at least one slushy beverage from within the at least one containment boundary).

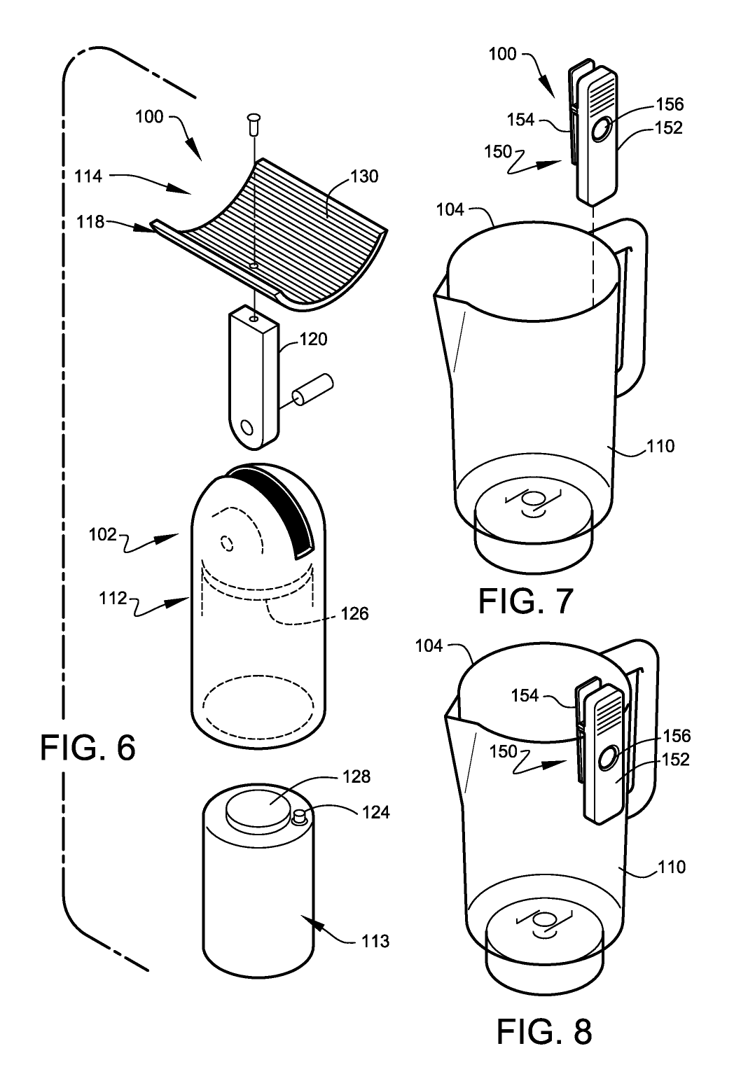

It should be noted that preferred embodiments of upper pivot cradle 114 are preferably matched to other commercially available blending pitcher shapes (non-cylindrical, as further described in FIG. 6). This preferred shape correspondence assists in securely stabilizing blending pitcher 104 adjacent pivot cradle 114 during a pouring movement.

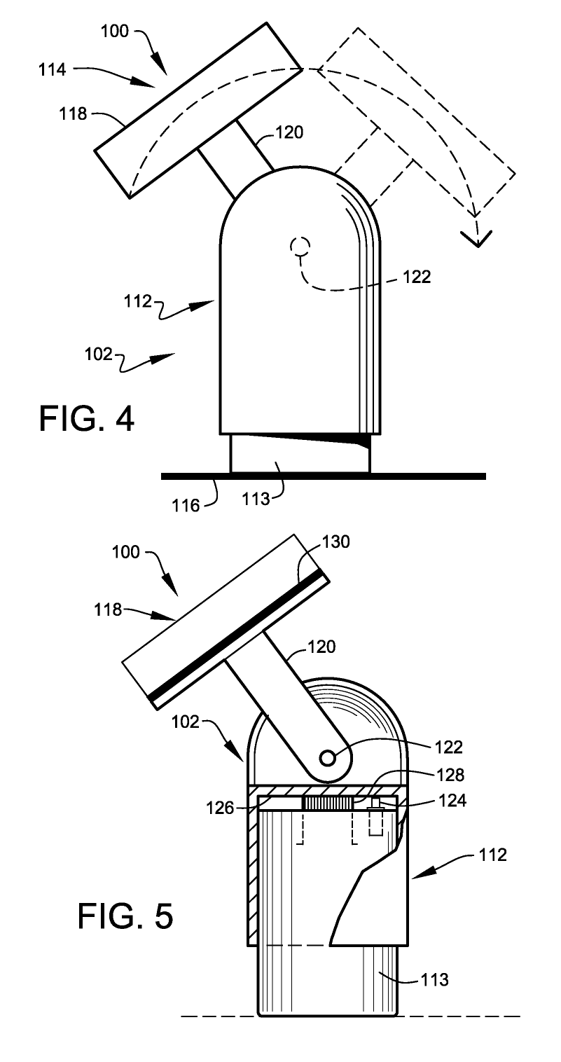

FIG. 3 shows an additional side view of beverage-pouring unit 102 of FIG. 2 illustrating a progressive dispensing of slushy beverage 106 into serving container 108. FIG. 4 shows a side elevational view illustrating the articulated motion of beverage-pouring unit 102 according to the preferred embodiment of FIG. 1. In the depiction of FIG. 3, pivot cradle 114 has been rotated downward toward serving container 108 (see also the arrow depiction of FIG. 4). During a pour, an oscillating mechanical force originating at vibration generator 113 is transmitted through pivot cradle 114 to the containment wall 110 of blending pitcher 104, as shown (at least embodying herein vibration transmitter means for transmitting such at least one mechanical vibration force from such vibrator means to the at least one containment boundary). Preferably, the oscillation force is applied continuously during the motion of the pour (at least embodying herein wherein, while guided along such at least one arc, the at least one containment boundary receives such at least one mechanical vibration force by such abutment with such surface abutter means). As a result, pourability and/or fluidization of slushy beverage 106 from blending pitcher 104 is greatly improved by the vibratory interaction with containment wall 110.

FIG. 5 shows a side view, in partial section, illustrating the internal assembly arrangements of beverage-pouring unit 102 of FIG. 1. FIG. 6 shows a diagrammatic exploded view of beverage-pouring unit 102. Preferably, assembly-housing 112 comprises a hollow interior cavity adapted to receive vibration generator 113, as shown. Preferably, vibration generator 113 is adapted to produce a vibration force by means of an electro-mechanical oscillator, more preferably an electromagnetic induction-type oscillator (at least embodying herein vibrator means for generating at least one mechanical vibration force having at least one frequency of oscillation).

Preferably, vibration generator 113 is powered by at least one external power source, with alternating electrical current supplied by a connection to a standard wall-type outlet being preferred (for example, a wall outlet supplying 120 V 60 HZ electrical power). Upon reading the teachings of this specification, those of ordinary skill in the art will now understand that, under appropriate circumstances, considering such issues as user preference, intended use, etc., other power arrangements, such as, low-voltage systems, on-board battery systems, rechargeable battery packs, etc., may suffice.

Preferred embodiments of vibration generator 113 utilize a motor driven shaft comprising an eccentrically mounted weight as the mechanical oscillator mechanism. The frequency of vibration is preferably dependent on the speed of the motor, while the momentary force of vibration is determined by the mass of the weight and the distance of offset relative to the axis of the rotating shaft. Alternately, the mechanical drive mechanism for vibration generator 113 preferably comprises an electromagnetic induction-type oscillator comprising a coil of wire wound on a core of metal. When current is applied to the coil, a magnetic field is generated. Preferably, the core itself is movable or is located in close proximity to a movable ferrous metal armature that is attracted by the magnetic field. When the electric current stops, the magnetic field collapses allowing the moveable core (or metal armature) to rebound to its original position. In this arrangement, the level of the vibration is dependent on the amount of current through the coil while the frequency is determined by the on-off cycle of the current. Preferably, one or more electrical controls (such as a diode) is connected in series with the coil, thus providing a pulsating current at the frequency of the alternating current power source. Upon reading the teachings of this specification, those of ordinary skill in the art will now understand that, under appropriate circumstances, considering such issues as cost, user preference, intended use, etc., other electrical control circuits, such as digitally generated oscillator control signals, mechanical current oscillators, etc., may suffice.

Preferably, the vibrational force generated within vibration generator 113 is transferred along a projecting vibration-conducting member 128 to the upper interior surface 126 of assembly-housing 112, as shown. Preferably, vibration-conducting member 128 is spring-loaded to assist in maintaining proper operational contact with assembly-housing 112, as shown. From the upper interior surface 126 of assembly-housing 112, the vibrational force is carried along the pivot arm 120 to shaped receiver 118 where the vibrational force is transferred to the containment wall 110 of blending pitcher 104 (at least embodying herein vibration transmitter means for transmitting such at least one mechanical vibration force from such vibrator means to the at least one containment boundary).

Preferably, vibration generator 113 comprises at least one user-operated control adapted to adjust the frequency of oscillation. Preferably, the operation of vibration generator 113 is controlled by a pressure-controlled variable resistance switch (or rheostat) identified herein as variable control switch 124. Preferably, variable control switch 124 is adapted to control the operational frequency of the electromechanical oscillator by altering the supply voltage or control signal level of the oscillator circuit (at least embodying herein trigger means for triggering the operation of such vibrator means).

Preferably, the level of pressure applied to variable control switch 124 by the upper interior surface 126 of assembly-housing 112 alters the supply voltage or control signal level within the oscillator circuit.

Preferably, assembly-housing 112 is adapted to translate vertically relative to vibration generator 113 under the downward pressure of blending pitcher 104 against shaped receiver 118. The downward pressure of blending pitcher 104 against shaped receiver 118 urges upper interior surface 126 against variable control switch 124 resulting in the depressing of variable control switch 124, as shown (at least embodying herein wherein such trigger means triggers the operation of such vibrator means by at least one pressure contact between the at least one containment boundary and such surface abutter means).

Preferably, as variable control switch 124 is depressed, the oscillation frequency of vibration generator 113 is progressively increased (at least embodying herein wherein such trigger means comprises frequency adjuster means for adjusting such at least one frequency of oscillation). Preferably, the spring-loaded feature of vibration-conducting member 128 biases the position of upper interior surface 126 upward and away from variable control switch 124, thus, the removal of blending pitcher 104 from shaped receiver 118 unloads the switch slowing the operation of vibration generator 113 to a stop. This highly preferred arrangement allows a user to automatically start the operation of vibration generator 113 on placement of blending pitcher 104 adjacent shaped receiver 118, adjust the level of vibration by modulating the pressure of blending pitcher 104 against shaped receiver 118 during the pour, and terminate the operation of the system by removal of the pitcher from the system. Upon reading the teachings of this specification, those of ordinary skill in the art will now understand that, under appropriate circumstances, considering such issues as intended use, user preference, etc., other control arrangements, such as, for example, manually controlled on/off switches, foot-operated controls, finger-adjustable frequency controls, controls comprising visual indicators, over-current breakers, etc., may suffice.

Preferably, for ease of manufacture, pivot arm 120 and shaped receiver 118 are fabricated as two independent structures, as shown. Preferably, pivot arm 120 and shaped receiver 118 are firmly coupled using at least one removable fastener arrangement, as shown. In this preferred arrangement, convenient interchanging of alternate shaped receivers 118, adapted to support alternate outer peripheral shapes of other popular blending pitcher models, is possible. For example, an establishment that uses a popular rectangular-shaped commercial blending pitcher 104 will preferably equip the end of pivot arm 120 with a “V”-shaped receiver shoe, thus accommodating the generally rectilinear corner shape of the pitcher. Upon reading the teachings of this specification, those of ordinary skill in the art will now understand that, under appropriate circumstances, considering such issues as advances in blender design, need to accommodate multiple blending devices, etc., other more “non-specific” receiver shapes such as shapes adapted to engage a generic range of container shapes, such as receivers comprising substantially planar contact surfaces, etc., may suffice. Furthermore, upon reading the teachings of this specification, those of ordinary skill in the art will now understand that, under appropriate circumstances, considering such issues as manufacturing cost, etc., other pivot arm/shaped receiver arrangements, such as, for example, using an integrally formed (one-piece) unit, etc., may suffice.

Preferably, shaped receivers 118 are constructed from a rigid, durable, and cleanable material, preferably plastic, most preferably stainless steel. Preferably, the contact surface 130 of shaped receiver 118 comprises a frictional surface with a layer of natural or synthetic rubber being preferred. Preferably, the interface between vibration-conducting member 128 and upper interior surface comprise at least one friction reduction feature, preferably a low friction surface, designed to assist in the smooth horizontal rotation of assembly-housing 112.

Preferably, assembly-housing 112 is adapted for easy removal from vibration generator 113 to provide a convenient means for periodic cleaning assembly-housing 112 apart from the electrically operated vibration generator 113. Upon reading the teachings of this specification, those of ordinary skill in the art will now understand that, under appropriate circumstances, considering such issues as intended use, etc., other assembly-housing arrangements, such as, for example, height adjusters to accommodate various serving contains, etc., may suffice.

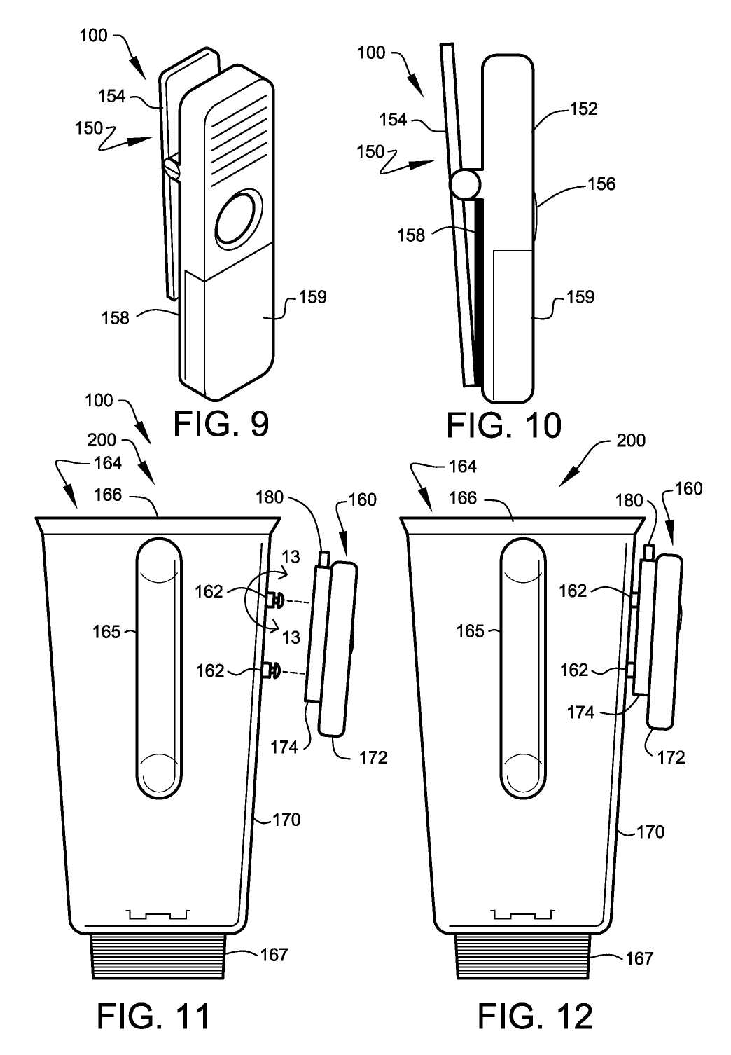

FIG. 7 shows a perspective view illustrating alternate beverage-pouring unit 150 of beverage-pouring system 100 comprising spring-loaded mount 152 adapted to mount alternate beverage-pouring unit 150 to containment wall 110 of blending pitcher 104 according to another preferred embodiment of the present invention. FIG. 8 shows a perspective view illustrating alternate beverage-pouring unit 150 mounted to containment wall 110 of blending pitcher 104 of FIG. 7. FIG. 9 shows a detailed perspective view of alternate beverage-pouring unit 150 with FIG. 10 showing a side view of the alternate beverage-pouring unit 150. In the following disclosure, reference made to FIG. 7 through FIG. 10 with continued reference to the prior teachings enabling the electro-mechanical oscillator structures of beverage-pouring unit 102.

Alternate beverage-pouring unit 150 is preferably adapted to improve the pourability of a slushy beverage by supplying a direct vibrational force to containment wall 110 of blending pitcher 104. Preferably, alternate beverage-pouring unit 150 can be quickly removed from one pitcher and placed on another so that a single device can be used for multiple pitchers.

Preferably, alternate beverage-pouring unit 150 comprises housing 152 containing an electro-mechanical oscillator. Preferably, housing 152 supports spring actuated mount 154 and control button 156, as shown. Preferably, alternate beverage-pouring unit 150 is mountable to containment wall 110 of blending pitcher 104 by situating containment wall 110 between housing 152 and spring actuated mount 154, as shown. Preferably, spring actuated mount 154 comprises at least one biasing spring to retain vibration-conducting surface 158 of housing 152 firmly against containment wall 110, as shown (at least embodying herein removable attacher means for removably attaching such assembly support means to the at least one container). Preferably, the portion of spring actuated mount 154 which is situated within the interior of blending pitcher 104 is of one-piece construction and easily cleanable so as not to allow contamination. Preferably, spring actuated mount 154 is sized to limit contact the slushy beverage during use. Preferably, vibration-conducting surface 158 comprises a nonskid surface to prevent the device from slipping against containment wall 110 during use. Preferably, the overall alternate beverage-pouring unit 150 is constructed so that it can be easily washed, to assist in maintaining appropriate levels of hygiene required in food preparation.

Preferably, the internal electro-mechanical oscillator of alternate beverage-pouring unit 150 is controlled by an externally mounted control button 156, as shown. Preferably, control button 156 provides a manual on/off control for the internal electro-mechanical oscillator. Preferably, the internal electro-mechanical oscillator of alternate beverage-pouring unit 150 is actuated by depressing control button 156 and remains operational until the button is released. Most preferably, control button 156 is of a variable type whereby the level of pressure applied to control button 156 alters the supply voltage or control signal level within the oscillator circuit, thus allowing the operator to actively control the force of vibration. Upon reading the teachings of this specification, those of ordinary skill in the art will now understand that, under appropriate circumstances, considering such issues as intended use, cost, etc., other control arrangements, such as, for example, controlling the oscillator using a positional switch (such as a mercury switch) to automatically initiate the operation of the oscillator on pouring, etc., may suffice.

Preferably, housing 152 is adapted to contain an internal power supply with an arrangement of on-board batteries being preferred. Preferred embodiments of alternate beverage-pouring unit 150 comprises an internal battery compartment situate below a removable battery access cover 159, as shown. Highly preferred arrangements comprise a rechargeable battery system with an external charger port adapted to receive a low-voltage direct current connector. Upon reading the teachings of this specification, those of ordinary skill in the art will now understand that, under appropriate circumstances, considering such issues as intended use, etc., other arrangements, such as, for example, wired electrical connections, inductive charging systems, the use of charging cradles to recharge one or more units between use, etc., may suffice.

FIG. 11 shows an elevational view illustrating alternate beverage-pouring assembly 200 of beverage-pouring system 100 comprising alternate beverage-pouring unit 160 and a modified blending pitcher 164, according to another preferred embodiment of the present invention. FIG. 12 shows an elevational view illustrating alternate beverage-pouring unit 160 mounted to the modified containment wall 170 of blending pitcher 164. Preferably, blending pitcher 164 comprises a modified containment wall 170 having an arrangement of pin-mounts 162 adapted to removably engage alternate beverage-pouring unit 160, as shown (at least embodying herein at least one coupler adapted to removably couple such at least one removable attacher to such at least one containment boundary).

Preferably, beverage-pouring unit 160 interoperates with a specially modified blending pitcher 164, as shown. Preferably, containment wall 170 of blending pitcher 164 is fitted with a set of projecting pin mounts 162 adapted to engage a complementary receiver assembly 174 located on the back of housing 172, as shown (at least embodying herein removable attacher means for removably attaching such assembly support means to the at least one container). Preferably, alternate beverage-pouring unit 160 can be quickly removed from one pitcher and placed on another so that a single device can be used for multiple pitchers.

Preferably, blending pitcher 164 comprises a liquid-holding container, with containment wall 170 forming a perimeter boundary, as shown (at least embodying herein such at least one containment boundary of such at least one blending pitcher comprises at least one peripheral side wall having at least one bottom wall portion). Preferably, blending pitcher 164 comprises at least one hand grip 165 adapted to assist hand gripping of the pitcher during use. Preferably, blending pitcher 164 is formed from a substantially rigid material with of glass or plastic being preferred. Preferably, the upper edge of containment wall 170 forms opening 166 for fluid entry and discharge (at least embodying herein at least one substantially open top portion defining such at least one fluid discharge). In addition, blending pitcher 164 preferably comprises a lower opening adapted to engage mixing assembly 167, as shown.

Preferably, one or more seals or rings can be disposed between mixing assembly 167 and blending pitcher 164 to form a seal so that blending pitcher 164 is resistant to leaks. Preferably, mixing assembly 167 includes one or more blades or stirring members that are rotatable or pivotable with respect to blending pitcher 164. Preferably, mixing assembly 167 is adapted to be removably coupled to the blending pitcher 164 so that it can be removed for cleaning. Preferably, mixing assembly 167 is coupled to the blending pitcher 164 by a threaded coupling, or a twist lock. Preferably, mixing assembly 167 is adapted to be operationally engagable with a motorized base unit adapted to drive the rotation of the blades (at least embodying herein at least one adapter seat seatable on at least one blender seat of at least one motor base). Preferably, mixing assembly 167 is adapted to engage one or more existing commercially available motorized base units. Motorized base units suitable for use with beverage-pouring system 100 include devices produced by Hamilton Beach/Proctor-Silex, Inc. of Washington, N.C. and Vita Prep line of products distributed by VitaMix Corporation of Cleveland, Ohio.

Preferably, housing 172 of alternate beverage-pouring unit 160 is substantially similar in design and construction to housing 152 of alternate beverage-pouring unit 150, preferably comprising an internal electromechanical oscillator, power supply, and manually controlled button 176, as shown.

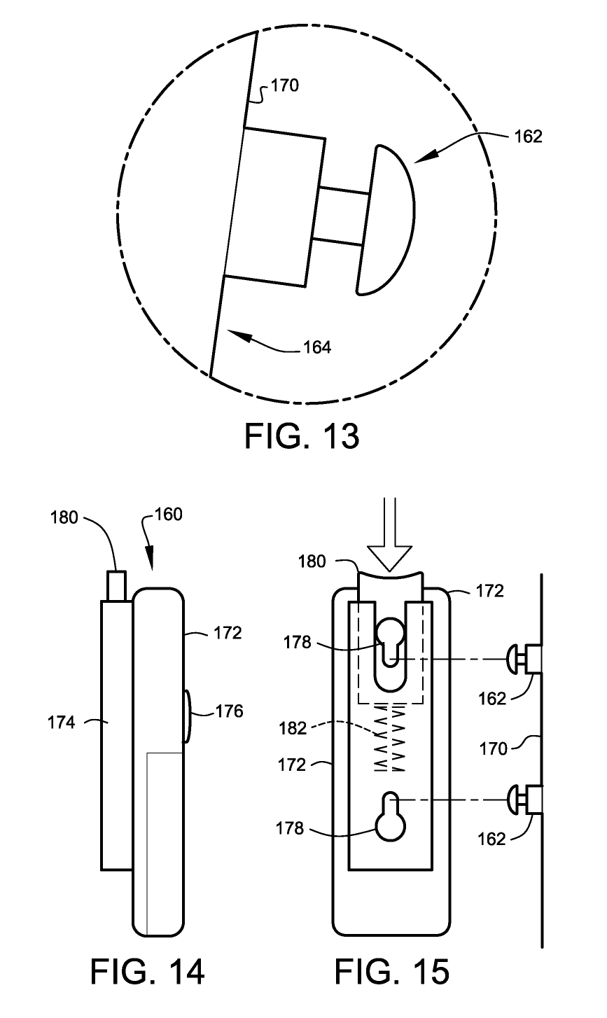

FIG. 13 shows the detail view 13-13 of FIG. 11 illustrating a single mounting pin 162 of modified containment wall 170. Preferably, each pin mount 162 comprises an outwardly projecting shaft terminating in an enlarged “button-head” portion, as shown.

FIG. 14 shows a side view of alternate beverage-pouring unit 160 of FIG. 11. FIG. 15 shows a rear view of alternate beverage-pouring unit 160 illustrating, in greater detail, receiver assembly 174. Preferably, receiver assembly 174 is adapted to couple the vibrating housing 172 to modified containment wall 170 in a firm but removable manner. Preferably, receiver assembly 174 is provided with a pair of keyhole-shaped apertures 178, as shown. Preferably, each keyhole-shaped aperture 178 includes a large diameter entrance or insertion portion transitioning to a smaller open U-shaped retainer portion, as shown. Preferably, in the embodiment shown, the smaller open U-shaped portions of the apertures are vertically aligned and are preferably placed in an opposing orientation, as shown. Preferably, in the depicted embodiment, the lower keyhole-shaped aperture 178 is fixed relative to housing 172 while the upper keyhole-shaped aperture 178 resides within sliding member 180, as shown. Preferably, the upper keyhole-shaped aperture 178 of sliding member 180 is biased away from the lower keyhole-shaped aperture 178 by internal spring 182, as shown. Preferably, to engage receiver assembly 174 on modified containment wall 170, the lower keyhole-shaped aperture 178 is engaged on the lower pin mount 162 while the user manually depresses sliding member 180 to align the large diameter entrance opening of the upper keyhole-shaped aperture 178. Once aligned, the upper keyhole-shaped aperture 178 is preferably engaged on the projecting shaft of upper pin mount 162, as best shown in FIG. 12. Releasing sliding member 180 firmly engages the enlarged button-head portion of the pin mounts 162 within the vibration-conducting structure of receiver assembly 174, as shown. Removal of receiver assembly 174 from containment wall 170 preferably entails a reversal of the above-described steps.

Preferably, pin mounts 162 are permanently mounted to containment wall 170, as shown. Most preferably, pin mounts 162 are integrally formed as part of containment wall 170. Preferably, pin mounts 162 are located in a position that does not interfere with the normal function of the blending container. Preferably, pin mounts 162 are located in a position that addresses operational convenience of the user, for example, locating button 176 adjacent the handle grip of the blending container.

Upon reading the teachings of this specification, those of ordinary skill in the art will now understand that, under appropriate circumstances, considering such issues as intended use, cost etc., other modified container arrangements, such as, for example, modifying the handle grip of a mixing pitcher to comprise a vibrating unit, incorporating a actuating trigger into the handle grip, locating a vibrating unit within the base of the mixing pitcher, etc., may suffice.

Preferably, each of the above-described preferred embodiments of the invention are constructed from materials that are easy to clean and meet health standards of the appliance industry. Wiring, switches and vibration devices preferably conform to prevailing standards for commercial electrical devices, preferably including standards established by Underwriters Laboratories (U.L.).

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A system relating to improving pourability of at least one slushy beverage held within at least one container, such at least one container comprising at least one containment boundary adapted to contain such at least one slushy beverage and at least one fluid discharge through which such at least one slushy beverage may discharge from the at least one containment boundary, comprising:
a) vibrator means for generating at least one mechanical vibration force having at least one frequency of oscillation;
b) trigger means for triggering the operation of said vibrator means; and
c) vibration transmitter means for transmitting such at least one mechanical vibration force from said vibrator means to the at least one containment boundary;
d) wherein said vibration transmitter means comprises surface abutter means for providing at least one vibratable surface abuttable with such at least one containment boundary;
e) wherein said surface abutter means comprises positioner means for assisting in positioning said surface abutter means in at least one operable position of abutment with the at least one containment boundary during such fluid discharge of such at least one slushy beverage from within the at least one containment boundary; and
f) whereby pourability of such at least one slushy beverage through the at least one fluid discharge is improved by vibratory interaction with the at least one containment boundary receiving from said vibration transmitter means such at least one mechanical vibration force generated by said vibrator means.

2) The system according to claim 1 further comprising assembly support means for supporting said vibrator means, said trigger means, and said vibration transmitter means.

3) The system according to claim 2 wherein said trigger means triggers the operation of said vibrator means by at least one pressure contact between the at least one containment boundary and said surface abutter means.

4) The system according to claim 3 wherein said trigger means comprises frequency adjuster means for adjusting such at least one frequency of oscillation.

5) The system according to claim 4 wherein said frequency adjuster means comprises variable pressure adjuster means for adjusting such at least one frequency of oscillation in substantial correspondence to varying levels of pressure contact between the at least one containment boundary and said surface abutter means.

6) The system according to claim 2 wherein said assembly support means comprises removable attacher means for removably attaching said assembly support means to the at least one container.

7) A system relating to improving pourability of at least one slushy beverage held within at least one container, such at least one container comprising at least one containment boundary adapted to contain such at least one slushy beverage and at least one fluid discharge through which such at least one slushy beverage may discharge from the at least one containment boundary, comprising:
a) at least one vibrator adapted to generate at least one mechanical vibration force having at least one frequency of oscillation;
b) at least one trigger adapted to trigger the operation of said at least one vibrator; and
c) at least one vibration transmitter adapted to transmit such at least one mechanical vibration force from said at least one vibrator to the at least one containment boundary;
d) wherein said at least one vibration transmitter comprises at least one surface abutter adapted to provide at least one vibratable surface abuttable with such at least one containment boundary; and
e) wherein said at least one surface comprises at least one positioner structured and arranged to assist in positioning said at least one surface abutter in at least one operable position of abutment with the at least one containment boundary during such fluid discharge of such at least one slushy beverage from within the at least one containment boundary;
f) whereby pourability of such at least one slushy beverage through the at least one fluid discharge is improved by vibratory interaction with the at least one containment boundary receiving from said at least one vibration transmitter such at least one mechanical vibration force generated by said at least one vibrator.

8) The system according to claim 7 further comprising at least one assembly support adapted to support said at least one vibrator, said at least one trigger, and said at least one vibration transmitter.

9) The system according to claim 8 wherein said at least one trigger triggers the operation of said at least one vibrator by at least one pressure contact between the at least one containment boundary and said at least one surface abutter.

10) The system according to claim 9 wherein:
a) said at least one trigger comprises at least one frequency adjuster adapted to adjust of such at least one frequency of oscillation; and
b) said at least one frequency adjuster is user controllable.

11) The system according to claim 10 wherein said at least one frequency adjuster comprises at least one variable pressure adjuster adapted to adjust such at least one frequency of oscillation in substantial correspondence to varying levels of pressure contact between the at least one containment boundary and said at least one surface abutter.

12) The system according to claim 11 wherein said at least one assembly support comprises at least one surface support structured and arranged to assist in the stable support of said at least one assembly support on at least one substantially horizontal support surface.

13) The system according to claim 12 wherein:
a) said at least one assembly support comprises
i) at least one pivot guide to pivotally guide said at least one surface abutter along at least one first arc, and
ii) at least one swivel adapted to guide said at least one surface abutter along at least one second arc;
b) wherein the at least one containment boundary is guidable along such at least one first arc and such at least one second arc by such abutment with said at least one surface abutter; and
c) wherein, while guided along such at least one first arc and such at least one second arc, the at least one containment boundary receives such at least one mechanical vibration force by such abutment with said at least one surface abutter.

14) The system according to claim 8 wherein said at least one assembly support comprises at least one removable attacher adapted to removably attach said at least one assembly support to the at least one container.

15) The system according to claim 14 wherein said at least one attacher comprises at least one spring clip.

16) The system according to claim 14 further comprising:
a) the at least one container;
b) wherein said at least one container comprises
i) at least one containment boundary adapted to contain such at least one slushy beverage, and
ii) at least one fluid discharge through which such at least one slushy beverage may discharge from the at least one containment boundary.

17) The system according to claim 16 wherein:
a) said at least one container comprises at least one blending pitcher adapted to assist in the preparation of such at least one slushy beverage;
b) said at least one containment boundary of said at least one blending pitcher comprises at least one peripheral side wall having at least one bottom wall portion;
c) said at least one peripheral side wall and said at least one bottom wall together comprise at least one interior portion;
d) said at least one interior portion comprises
i) at least one substantially open top portion defining said at least one fluid discharge, and
ii) at least one cutter blade adapted to assist in the preparation of such at least one slushy beverage;
e) said at least one peripheral side wall comprises at least one grip adapted to assist manual gripping of said at least one blending pitcher;
f) said at least one bottom wall comprises at least one adapter seat seatable on at least one blender seat of at least one motor base; and
g) said at least one cutter blade comprises at least one rotational coupler to rotationally couple said at least one cutter blade with the at least one motor base.

18) The system according to claim 16 wherein said at least one container comprises at least one coupler adapted to removably couple said at least one removable attacher to said at least one containment boundary.

19) The system according to claim 18 wherein:
a) at least one of said at least one coupler and said at least one removable attacher comprises at least one post adapted to removably engage at least one socket;
b) at least one of said at least one coupler and said at least one removable attacher comprises such at least one socket adapted to removably engage said at least one post; and
c) said at least one coupler is removably coupled to said at least one removable attacher using said at least one post removably engaged within said at least one socket.

20) A beverage handling system relating to improving the pourability of at least one slushy beverage held within at least one pitcher by reducing the effective viscosity of such at least one slushy beverage during the arc of a pour, comprising:
a) at least one pitcher support adapted to support the at least one pitcher during the arc of a pour;
b) at least one support vibrator adapted to generate at least one vibration force to vibrate said at least one pitcher support; and
c) at least one vibration transmitter adapted to transmit such at least one vibration force of said at least one pitcher support to such at least one pitcher.
